(19) United States
(12) Patent Application Publication
(10) Pub. No.: US 2017/0134471 A1
(43) Pub. Date: May 11, 2017

(54) Web-Based Client for Providing Real-Time Communications

(71) Applicant: GENBAND US LLC, Frisco, TX (US)

(72) Inventors: John K. Mathew, Emerson, NJ (US); Swapan Nandi, Plano, TX (US); Dany Sylvain, Gatineau (CA); Carlos David Aragon Sanchez, The Colony, TX (US); Andy Lee, Nepean (CA)

(73) Assignee: GENBAND US LLC, Frisco, TX (US)

(21) Appl. No.: 14/936,755

(22) Filed: Nov. 10, 2015

(51) Int. Cl. H04L 29/06; H04L 29/08

(52) U.S. Cl. CPC H04L 65/608; H04L 67/02; H04L 65/1006

(57) ABSTRACT

Methods and systems are disclosed for providing real-time communications services to a user. A service node provides user interaction instructions and functional execution instructions to a communication application container executing on a computing host. The user interaction instructions include instructions for the display by a web client of a real-time communications graphical display, such as a softphone graphical interface. A real time communication service is configured by the service node based on user input to the graphical display executing on the communication application container. The service node provides the real time communication service to the user of the computing host based on the functional execution instructions executing on the communication application container.

### TECHNICAL HELD

This disclosure relates generally to improvements in real-time communication capabilities, in particular a web-based client application for providing voice communication capabilities.

### BACKGROUND

The following discussion sets forth the inventors' own knowledge of certain technologies and/or problems associated therewith. Accordingly, this discussion is not an admission of prior art, and it is not an admission of the knowledge available to a person of ordinary skill in the art.

Web browsers can be used to provide access to software programs can configure customized user interfaces. Providing a software program as a web application allows the software program to be largely independent of the underlying operating system. Another major advantage of using web applications is the ability to provide access to software without having to deliver and install software to the user's computer.

For many years, software applications were distributed via CDs or other media that were sold to the customer either directly or via third-party merchants. Taking advantage of improvements in network bandwidth and storage capacity, downloading software via the Internet eventually became the preferred mechanism for providing software to users. Taking this one step further, rather than deliver the software program to the user and rely on the software to be correctly installed and updated, many software applications are now offered as services that run on centralized servers with only thin-client interfaces provided to the user. This has significantly improved the ability for software companies to support and improve their products. It has also improved the ability of software companies to limit the use of their software to licensed customers.

In the next step in this evolution, web browser based environments are becoming an increasingly popular mechanism for providing software to a distributed set of users. Just as software-as-a-service moved application software from the user's computer to centrally located servers, web based applications have similarly moved the user's application environment to a remote server. Users of a web based applications are provided with a URL that downloads a thin client that supports the display of the application on the user's device, the Graphical User Interface (GUI) and part of the application logic runs on the web browser and the rest runs on the server. By providing web based applications, enterprises benefit from centralized administration and security of the software applications provided to the user.

Running applications from a web browser provides significant advantages. For example, users always run the latest version of the application, there is no need to download or install new versions. If there are new features or changes to the GUI they are applied on the server without requiring any user intervention. However, using a browser also presents several challenges, some of which result from users needing to keep multiple browser windows open at once. Since web applications are not tightly integrated with the operating system, it is difficult for users to differentiate between a web based application and all other open web browser windows. There are other usability difficulties associated with web based applications. For example, switching between browser tabs using keyboard shortcuts is not as natural as switching between applications, alerts from the web application don't appear in the same place as native application alerts, and the application is represented in the task bar and program launcher as another instance of the web browser, whereas a native applications may utilize distinctive icons. These difficulties are emphasized when web applications are run on a mobile device. For instance, switching from the web browser to a native application on a mobile device may effectively suspend the web browser as a result of mobile device procedures for preserving battery power and network resources. Such limitations render some real time applications unusable on mobile devices. These challenges result on users favoring native applications over web based applications.

An example of a software application that may be used from a web based environment is a real-time communication client. For instance, a softphone is a real-time communication client that provides a user with a graphical interface for initiating, configuring and participating in voice and/or video calls. Users prefer to have an application such as softphone running natively on their device so that they can receive real time alerts for voice and video calls and messages, switch easily to the application to initiate new conversations, check presence or search the address book.

One option for embedding a real-time client, such as a softphone, in a web based environment is to utilize the WebRTC (Web Real Time Communications) protocols and APIs (Application Programmer Interface). WebRTC provides the tools for an application to access the hardware resources of the host device through a web browser. WebRTC also allows web browsers to establish real-time communication connections using RTP communications. The RTP communications utilized by WebRTC can be transmitted using protocols such as UDP and HTTP that are supported by web browsers. Using WebRTC, a softphone client can be provided as an embedded web browser application.

A problematic aspect of providing a softphone interface via a web browser is the incompatibility between a user's normal use of a web browser and a user's expectations for a telephone device. Users are accustomed to opening and closing web browsers as needed. A user may leave a web browser open indefinitely, but users are accustomed to closing a web browser once their present use of the browser is complete. For instance, users checking online for sporting event scores or to find a recipe are accustomed to being able to close the web browser once these tasks are complete. In this manner, users are accustomed to using web browsers for discrete tasks and closing the web browser until it is needed again. In addition to closing a web browser once a discrete task is completed, users are also accustomed to manipulating web browsers as windowed components of a desktop whereby the web browser can be minimized or stacked among other instances of the web browser and other applications that are being displayed in the desktop. User are accustomed to cycling between web browsers instances other supported applications as needed by moving a selected browser to the forefront of the display. Another disadvantage of a web-based application is the confusion caused by providing the user with separate menus for the web-based application and the web browser, with the web browser menus often providing little added value to the web-based application. As before, these problems are magnified on mobile devices because mobile operating systems typically conserve battery power by suspending the web browser when the user switches to another application.

A user's expectations for use of a telephone are significantly different than those for use of a web browser. Once a telephone device is powered and connectivity to a calling network is established, users are accustomed to having a telephone at their disposal, both for making and receiving calls. Users view a telephone as providing a continuous service rather than just a device for completing discrete tasks. Consequently, providing a softphone client as a web application can be a frustrating experience for users since by closing the web browser from which the softphone client is running, the user is disconnecting their telephone from the network such that no calls can be made or received.

Accordingly, there is a need for a softphone client that can be supported as a web application, while proving the user with telephone functionality that comports with their expectations for telephone service. To address these and other needs, the inventors hereof have developed a client application that provides real-time communications via an embedded web client component, as described in detail below.

### SUMMARY

Methods and systems are claimed for providing improved real-time communication services to users. The claimed invention utilizes a service node to provide the real-time communication services to users, that may be using different computing host types. The real-time communication services are provided via a communication application container executing on the computing host of the user, the communication application container integrated as a native application. The communication application container receives instructions from the service node for the display of a graphical user interface, such as a softphone client, in a web-client component of the communication application container. The service node also provides functional instructions to the communication application container, these functional instructions being used to support configuration and transmission of real-time communication sessions. A softphone interface configured in this manner provides a user with phone service capabilities that comport with a user's expectations from a native softphone client that utilizes a web client user interface.

Methods and systems are described, for providing real-time communication services to a user according to various embodiments. User interaction instructions and functional execution instructions are provided from a service node to a communication application container executing on a computing host, wherein the user interaction instructions include instructions for the display by a web client of a real-time communications graphical display. A real time communication service is configured based on user input to the graphical display executing on the communication application container. The real time communication service is provided based on the functional execution instructions executing on the communication application container.

According to additional embodiments, the functional execution instructions include instructions for at least one of: selecting an audio input device; controlling parameters such as volume, echo cancellation and codec type that are associated with a selected audio input device; selecting a video input device; controlling parameters, such as resolution, frame rate, codec type, that are associated with a selected video input device; selecting an audio output device for user alerts; selecting an audio output device for communication media; recording locally a communication session; getting current location data, such as GPS, WiFi, and cellular cell data; obtaining list of available network interface; selecting a network interface for a communication flow; getting network quality metrics for a network interface; accessing or updating a personal directory provided by a computing host; authentication via a SIM card; authentication via a fingerprint reader; launching another application on the computing host; presenting a visual notification for an event via the computing host notification methods; controlling windows formatting; receiving touch events from a touchscreen; configuring a cellular network dialer for normal and emergency calls; configuring cellular messaging; and configuring cellular RCS (Rich Communication Services.

According to additional embodiments, the user interaction instructions are web-based instructions on web-based protocols and methods such as HTML, HTML5, JAVASCRIPT and CSS. According to additional embodiments, the real time communications between the communication application container and the service node may be provided using protocols and methods such as REST, SOAP, and JSON. According to additional embodiments, the service node interacts with a real time communication network using SIP. According to additional embodiments, the communication application container may transmit real time communication media using protocols such as RTP. According to additional embodiments, the communication application container provides a primary telephony or messaging user interface for a mobile device. According to additional embodiments, the real time communication services include at least one of: audio, video, messaging, screen sharing, application sharing, co-browsing, whiteboard sharing, annotation, remote control, and streaming. According to additional embodiments, the communication application container includes an abstraction layer which provides a consistent interface for the user interaction instructions and functional execution instructions across different computing host types. According to additional embodiments, the user interaction instructions provided by the service node are selected based on a user profile.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items. Reference will now be made to the accompanying drawings, wherein:

FIG. 1 is a block diagram of a conventional real-time communications system utilizing a native communication application.

FIG. 2 is a block diagram of a conventional real-time communications system utilizing a web-based communication application.

FIG. 3 is a block diagram of a system for providing real-time communications according to some embodiments.

FIG. 4 is block diagram of a system for providing real-time communications according to some embodiments,

FIG. 5 is a block diagram of a set of graphical user interfaces and system components used to provide real-time communications according to some embodiments.

FIG. 6 is block diagram of a system for providing real-time communications to multiple users according to some embodiments.

FIG. 7 is a flowchart of certain steps of a method for configuring a set of graphical user interfaces for providing real-time communications according to some embodiments.

FIG. 8 is block diagram of an illustrative device that could be used to implement the real-time communication system according to some embodiments.

FIG. 9A is a call flow diagram illustrates certain steps of a method for configuring a set of graphical user interfaces for providing real-time communications according to some embodiments.

FIG. 9B is a call flow diagram illustrates certain additional steps of the method of FIG. 9A.

### DETAILED DESCRIPTION

Embodiments disclosed herein are directed generally to configuring and providing a set of web-based graphical user interfaces for setting up and participating in real-time communications sessions.

The term “telecommunications,” as used herein, is intended to encompass voice communications or telephony, as well as other forms of communications (e.g., video communications, videoconferencing, instant messaging or IM, Short Messaging Service or SMS, emails, etc.) that may take place electronically, for example, over wireless networks, circuit-switched networks, packet-switched networks, or any combination thereof. As such, a reference to a “call” in the description of embodiment of the claimed invention may encompass a voice call, a video call or a data message. Also, a reference to a “conversation” may encompass a voice call, a video call, a data message or any combination of them.

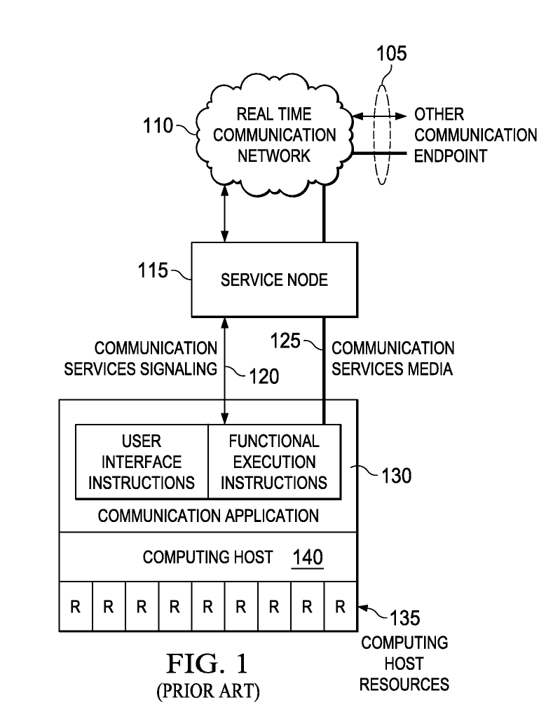

A conventional system for providing real-time communications to a user of a native communication application is illustrated in FIG. 1. In this conventional system, the computing host 140 executes a real-time communication application 130, such as a softphone client, that interfaces with a service node 115, such as a private branch exchange, to support a real-time communication with a user of a remote video/voice device 105.

In the conventional scenario of FIG. 1, a real-time communications client, such as softphone client, executes on the computing host 140 and provides the user with a graphical interface by which to initiate voice and/or video calls. For example, the softphone graphical interface is used to dial the phone number associated with a remote device 105. The connection is established and maintained by the service node 115. In a typical real-time communication system, a signaling protocol is used to transmit call control commands along communication services signaling pathway 120 in order to setup a connection between the computing host 140 and the remote device 105. For example, the service node 115 receives a call setup request via communication services signaling pathway 120 and uses the received information and communication services media pathway 125 to communicate call data with the remote device 105. Session Initiation Protocol (SIP) is a common signaling protocol used for setting up real-time communication sessions between two network endpoints. In the conventional scenario of FIG. 1, the service node 115 communicates with the remote device 105 and the computing host 140 using SIP to configure a call between these two devices.

Once a call between the computing host 140 and the remote device 105 has been configured, communication pathway 125 is used to transmit the real-time data stream between the two endpoints via service node 115. The real-time data stream encodes the voice and/or video data transmitted between the computing host 140 and the remote device 105. Typical systems that support real-time communications utilize communication protocols that are suited for transmission of real-time data streams. Real-time Transport Protocol (RTP) is a protocol that is specifically adapted for the real-time transmission of data between two network endpoints.

A problematic aspect of conventional native applications such as illustrated in FIG. 1 is the relative difficulty in updating the native application. Although service node 115 can utilize communication services signaling pathway 120 and communication services media pathway 125 to establish communication sessions on behalf of computing host 140, service node must do so using the communication application software 130 that is supported by the computing host 140. Native applications, such as the communication application 130, are comprised of user interfaces and functional components that implement the features provided by the user interface. Updating the user interface or the functional components in the convention native applications requires updating the communication application software 130 installed on the computing host 140.

One advantage of communication application 130 being a native application is that the application is tightly integrated with the computing host 140 operating system. This provides the communication application 130 with access and control of the resources 135 of the computing host 140. These resources will typically include peripheral devices such as microphones, cameras and speakers as well as networking and data storage resources of the computing host 140.

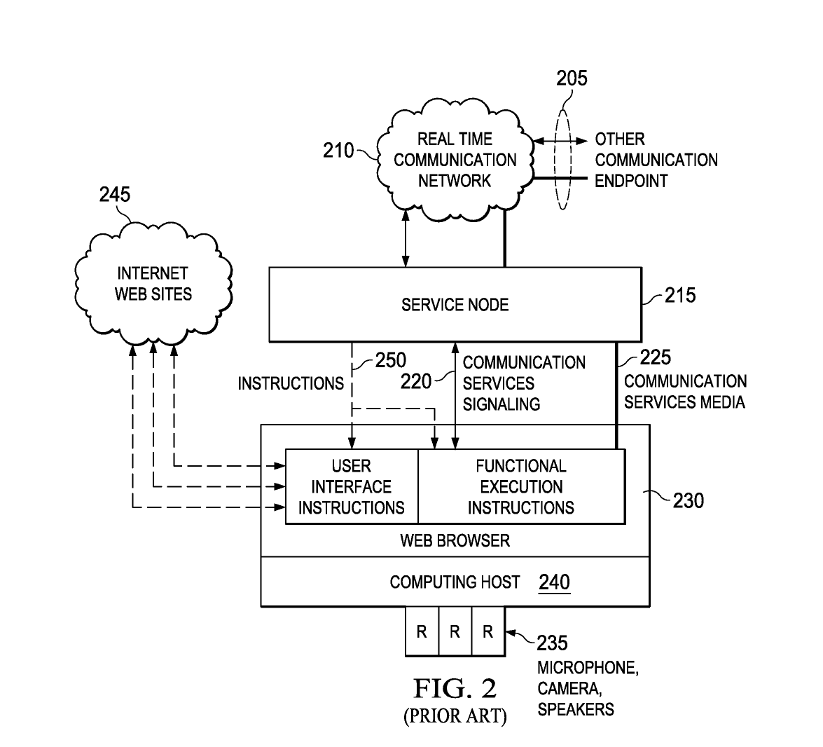

FIG. 2 illustrates another conventional scenario for providing real-time communications to a user. In the conventional scenario of FIG. 2, real-time communication services are provided to the user via a web browser 230, such as a WebRTC enabled browser, that is supported by the computing host 240. The application logic and graphical user interface (GUI) utilized by the real-time communication application are downloaded from a web server and executed within the web browser 230. As before, the service node 215 establishes and manages real-time communication sessions between the computing host 240 and the remote device 205. However, unlike the scenario of FIG. 1, since the real-time communication application is a component of the web browser 230, the application uses different signaling and media protocols for communicating with the service node 215. These signaling and media protocols conform with web standards, such as WebRTC, rather than telephony standards that are used by the native application of FIG. 1 to configure and conduct a real-time communication session.

As a component running on the web browser, the real time communication application of the conventional system of FIG. 2 utilizes the communication services signaling pathway 220 and the communication services media pathway 225 supported by the 215 service node. The graphical interface of the real-time client, such as a softphone interface, is displayed on the web browser 230 of the computing host 240. Via inputs to the graphical interface, a user initiates a voice/video call with the remote device 205. The inputs to the graphical interface that is displayed on the computing host 240 are processed by the code running in the web browser 230 and result in the invocation of functions from the service node 215 using the communication pathways 220 and 225.

As with the convention native application of FIG. 1, a call between the computing host 240 and the remote device 205 is set up by the service node 215 using a signaling protocol. The service node 215 receives a call request via communication pathway 220 and sets up the call with the remote device 205 via a real-time communication network 210. As with the conventional system of FIG. 1, the call may be setup using commands provided by a signaling protocol such as SIP.

Since the conventional real-time communication application of FIG. 2 is a component of the web browser 230, the application must use the communication interfaces provided by the web browser 230 to send and receive real-time data such as voice and video calls. For instance, voice data provided as an input to the communication application is transmitted to the service node 215 via the communication services media pathway 225 provided by the web browser. The user agent executing on the service node 215 then forwards the voice data to the real time communications network 210 using a protocol such as SIP. The voice data is then forwarded to the remote device 205, again using a protocol such as SIP. Likewise, voice data from the remote device 205 is received by the service node 215 and is forwarded via communication services media pathway 225 to the real-time communication application executing on the web browser 230.

Where the native real-time communication application of FIG. 1 had the benefit of being tightly coupled to the computing host, the web browser based communication application of FIG. 2 is limited by the security restrictions placed on web browsers. For instance, in the convention web-based communication application of FIG. 2, the web browser 230 is able to access a limited amount of predetermined and preconfigured resources or the computing host 240. For instance, the web browser 230 may only have access to certain I/O peripherals 235, such as a microphone, camera and speakers, of the computing host 240. Another disadvantage of using a web browser based application is the inability to restrict the network resources that are accessed. For instance, users of the web browser 230 may utilize the browser to access any internet web site 245. This creates difficulties in preventing the user from opening additional browser instances that will starve the real-time communication client of network and processing resources.

The embodiments of the claimed invention that are described and illustrated below utilize a communication application container that replaces the web browser to provide the user with a softphone user interface. In such embodiments, the communication application container is configured to provide a softphone user interface on the user device via direct interaction with the calling network.

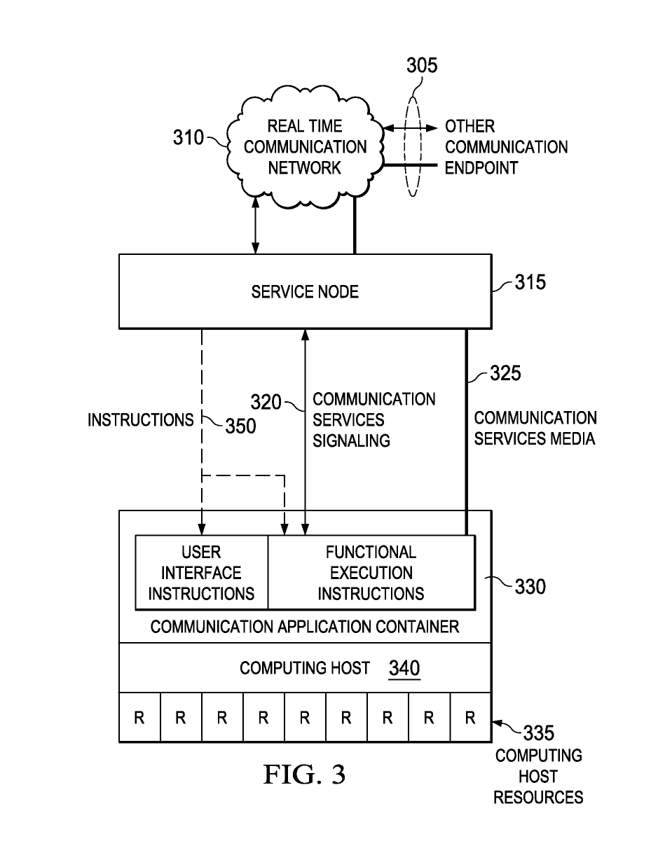

FIG. 3 illustrates an embodiment of a system that includes a real-time communications client that runs in the communication application container 330. In this embodiment, the communication application container 330 includes a softphone client comprised of user interface instructions and functional execution instructions. The softphone client is provided to a user by the communication application container 330 as a native application of the computing host 340. The softphone client is comprised of a graphical interface that is displayed on the computing host 340. As described in additional detail below, various illustrative embodiments are provided that describe softphone graphical interfaces that may be provided. The softphone graphical interface provides the user of the computing host 340 with the ability to participate in voice and/or video calls with the user of the remote device 305.

Unlike the conventional system described with respect to FIG. 2, the embodiment of FIG. 3 utilizes the communication application container 330 in place of the web browser provided by the computing host 340. In the embodiment of FIG. 3, the softphone client application is a component of a web client that is incorporated as a component of the communication application container 330. The softphone client includes a softphone graphical interface that is displayed within the communication application container 330, with the softphone client appearing as a native application of the computing host 340.

In the embodiment of FIG. 3, the web-client component of the communication application container 330 is used to implement the graphical interface of the real-time communication application provided to the user of the computing host 340. As a web-client, this graphical interface may be updated by the service node 315 via instruction pathway 350 during initialization of the softphone client. Embodiment may also enable updates to the graphical interface via pathway 350 during operation of the softphone client by the user. In this manner, new features can be provided to the user without requiring the user to install a software update to upgrade the functionality of the softphone client.

The service node 315 is responsible for configuring and supporting real-time communication sessions on behalf of communication application container 330. In some embodiments, service node 315 is configured to operate as a SIP endpoint on behalf of communication application container 330. In the embodiment of FIG. 3, service node 315 configures real-time communication sessions via communication services signaling pathway 320 and transmits call data to and from the communication application container 325.

In the embodiment of FIG. 3 the softphone client provided by the communication application container 330 is further comprised of a set of functional execution instructions that implement the real-time communications functions. These functional instructions are used to transmit signaling and call data to and from service node 315 via communication service signaling pathway 320 and communication services media pathway 325, respectively. In order to support the real time communication functions, the communication application container 330 must interface with the I/O resources 335 of the computing host 340. As a native application, communication application container 330 is able to interface with a wider set of I/O resources 335 when compared to the conventional web-based system of FIG. 2. The configuration of these computing host resources 335 by the communication application container 330 are described in additional detail below.

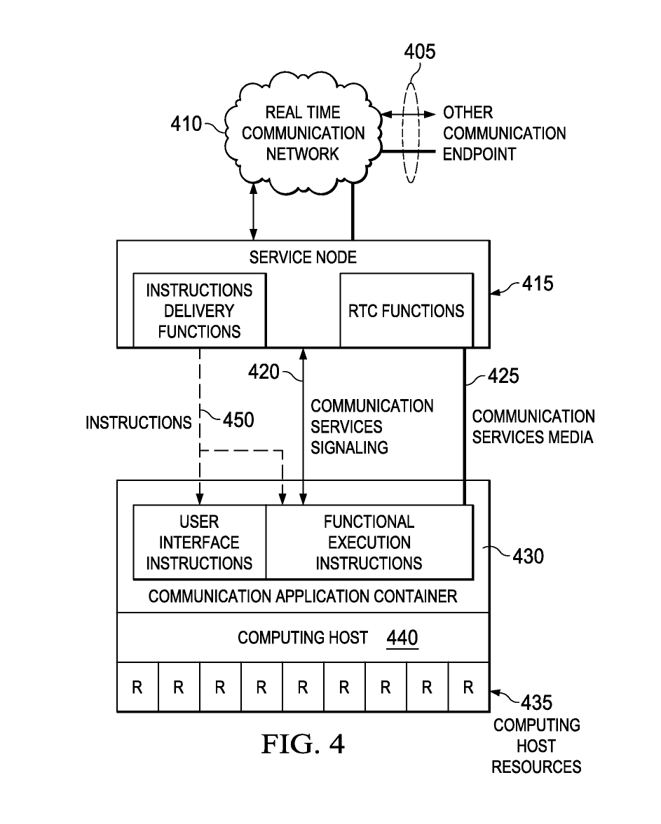

The embodiment of FIG. 4 illustrates a more detailed view of a service node 415 used to provide real-time communication services to communication application container 430 operating on computing host 440. Service node 415 is comprised of instruction delivery functions and real time communication functions components. The instruction delivery functions are used by the service node 415 to provide graphical display instructions 450 to the communication application container 430. The graphical display instructions 450 may be comprised of both instructions for display of softphone user interface via the web client component of communication application container 430 and instructions for the processing of information related to the softphone graphical interface by the functional execution instructions component of the communication application container 430.

The service node 415 is further comprised of a real time communication functions component that is used to configure and conduct real-time communications on behalf of communication application container 430. The real-time communications functions include functions by which the service node 415 serves as a SIP endpoint on behalf of the communication application container 430 and configures calls using the softphone interface. The real-time communications functions also include instructions for transmitting call data via communication service media pathway 425. In certain embodiments, the communication service media pathway 425 utilizes WebRTC protocol for communicating call data between computing host 440 and service node 415. WebRTC provides a mechanism for supporting real-time communication sessions from within the communication application container 430.

Since the web client component of the communication application container is built on web technology, the communication application container is configured to adhere to certain restrictions imposed by web standards (e.g., HTML5, CSS3, JAVASCRIPT). As a result the softphone client behaves as a web component in certain aspects. As a web-client, the softphone client interface can be constructed in a dynamic fashion when the graphical interface is initialized. In order to construct the softphone graphical interface, the communication application container invokes a URL or similar resource identifier that provides the instructions and data necessary to build the softphone display. In certain embodiments, the communication application container retrieves these display instructions based on a user profile. The user profile is used to provide the communication application container with instructions for constructing a display that is customized according to information provided in the user profile. In some embodiments, the user may be provided with controls by which to re-configure the appearance and/or the functionality of the softphone graphical interface.

For example, a user profile may indicate that a particular look and feel is preferred by a user. In such embodiments, the retrieved softphone graphical interface will conform to a layout and style previously identified by the user. In another example, a user profile may specify that controls for certain calling features, such as hold, mute or conference functions, should be displayed by default, while other features can be manually displayed by the user through menu selections. In such embodiments, the retrieved softphone graphical interface will incorporate these controls into the display. In other embodiments, the user profile will specify a user's job function, such as a secretary or a receptionist, which will be used to determine which controls will be included in the softphone graphical display for this user. In other embodiments, the user profile will specify which features have been purchased by the user, such that only the controls for purchased features are incorporated into the softphone graphical interface.

Another form of customization present in certain embodiments is the ability to incorporate address book and/or contact list information into the softphone graphical interface. In certain embodiments, the display information utilized by the embedded softphone client includes information from the user's address book and/or contact list. For instance, the softphone graphical interface may be customized to include quick dial buttons for certain address book and/or contact list entries, such as the people with whom the user converses most frequently. In some embodiments, the address book and/or contact list are comprised within the user's profile. In some embodiments, the address book and/or contact list are retrieved from a remote source as needed.

In some embodiments, the softphone graphical interface will provide the user with the ability to further configure ongoing communication sessions. In such embodiments, the softphone graphical interface includes controls for functions such as conferencing in another party to a call and placing a caller on hold. As described, these functions for configuring an existing call may be included and arranged within the softphone graphical interface based on information contained in the user's profile. In some embodiments, the controls for features used to configure ongoing communication sessions will not be displayed in the softphone graphical interface until a call has been established such that there is an ongoing call that can be configured.

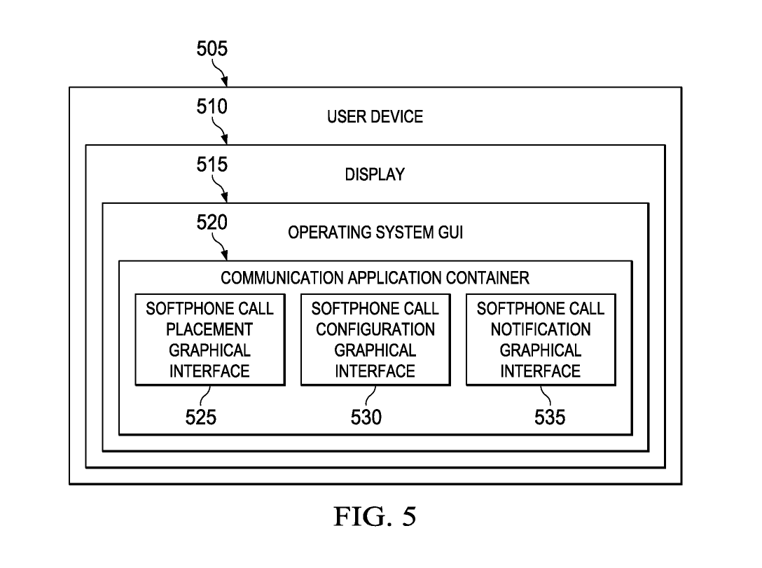

FIG. 5 illustrates another embodiment where the softphone graphical interface is divided into three interfaces, each configured to support specific aspects of the softphone in a manner that comports with user's expectations for conventional telephone devices. Further embodiments may utilize multiple additional interfaces in addition to or in place of these three types of interfaces utilized in the embodiment of FIG. 5. As in the embodiment of FIGS. 3 and 4, the softphone graphical interface is provided as a component of a communication application container 520 that is rendered in the operating system GUI 515 that is displayed on a user device 505. In the embodiment of FIG. 5, the softphone graphical interface is comprised of three separate user interfaces.

The first softphone user interface component is a call placement graphical interface 525. This is the default interface provided to the user when there is no ongoing call and no incoming call notifications are pending. The call placement graphical interface 525 provides the user with the functions necessary to place outgoing calls. As described with respect to the embodiment of FIG. 3, the call placement graphical interface 525 is configured based on a user profile. Based on preferences and other information specified in the user profile, the call placement graphical interface 525 can be customized, in some embodiments, to provide a preferred look and feel, controls for functions preferred or most frequently utilized by the user and incorporation of selected address book and/or contact list information into the display. In this manner, various embodiments of the call placement graphical interface 525 can be customized according to the needs and preferences of the user.

As a component of web browser, the call placement graphical interface 525 may be comprised as a standalone instance of the browser within the communication application container 520. As such, the call placement graphical interface 525 may be manipulated as a web browser in certain respects. In some embodiments, the call placement graphical interface 525 may be configured such that it retains the windowing functionality of a web browser. In such embodiments, the call placement graphical interface 525 may be minimized or hidden such that it is no longer displayed is instead represented in the toolbar of the user display or in some other area designated by the operating system GUI 515. In some embodiments, the call placement graphical interface 525 may be configured to be further minimized such that it is represented only by an icon in the notification area of operating system GUI 515. When minimized, the user may utilize windowing functionality provided by the operating system GUI 515 in order to restore the call placement graphical interface 525 to a visible state. In some embodiments, the user may be provided with the capability of retaining the call placement graphical interface 525 as a visible component of the operating system GUI 515 that cannot be minimized and thus always remains visible on the user device 505.

In some embodiments, the second softphone user interface component is the call configuration graphical interface 530. The call configuration graphical interface 530 may provide status information to the user. When displayed in the communication application container 520, the call configuration graphical interface 530 may include status indicators such as icons that represent whether the softphone client is currently connected to the calling network and is able to send and received calls. In situations where the call configuration graphical interface 530 is minimized, these status indicators may be displayed in a similar fashion using icons that represent whether the softphone client is presently connected to the calling network.

As opposed to the call placement graphical interface 525 that is displayed by default in certain embodiments, the call configuration graphical interface 530 is displayed when there is an ongoing call. In some embodiments, the call configuration graphical interface 530 may be displayed instead of the call placement graphical interface 525 and in other embodiments the call configuration graphical interface 530 may be displayed as a companion interface to the call placement graphical interface 525. The call configuration graphical interface 530 provides controls that can be used to modify an ongoing call. For instance, in some embodiments, the call configuration graphical interface 530 includes controls for placing a party on hold, conferencing in new parties and muting. In some embodiments, the call configuration graphical interface 530 may also provide data regarding the call, such as its duration, a list of the other parties on the call and/or quality of service metrics indicating the strength of the connection.

As with the call placement graphical interface 525, the call configuration graphical interface 530 may be configured as a standalone window in the communication application container 520. Configured in the manner, the call placement graphical interface 525 can be configured such that in can be minimized to the toolbar or other area of the operating system GUI 515. In some embodiments, the call placement graphical interface 525 can be configured to remain as a visible window of the operating system GUI 515 as long as an ongoing call session remains active.

In some embodiments, the third softphone user interface component is the call notification graphical interface 535. The call notification graphical interface 535 is only displayed on the operating system GUI 515 when an incoming call is pending. Upon receiving notification of a request for an incoming call, the softphone interfaces displayed on the communication application client 520 are updated to include the call notification graphical interface 535. In some embodiments, the call notification graphical interface 535 will be a companion interface to the call configuration graphical interface 530 or the call placement graphical interface 525. In some embodiments, the call notification graphical interface 535 will be presented to the user as a pop-up notification providing the user with information regarding the incoming call request. For instance, pop-ups may be provided as notifications associated with the toolbar of the operating system GUI 515.

In some embodiments, the call notification graphical interface 535 may provide the user with information identifying the incoming caller. In embodiments that utilize SIP, the invitee may provide identifying information as meta-data associated with a SIP call invite. In some embodiments, the call notification graphical interface 535 may interface with the user's address book and/or contact list in order to identify the incoming caller. In some embodiments, the call notification graphical interface 535 may provide the user with information regarding the date and time of last call from the incoming number. In some embodiments, the call notification graphical interface 535 may interface with databases that provide information regarding the identity of callers associated with an individual phone number. Using such databases, the call notification graphical interface 535 can be used to identify calls from known telemarketing entities and configured to provide this information to the user.

As a component of a web browser running in a communication application container, each of the described softphone graphical interfaces may be configured in some embodiments as a borderless containers that occupy an entire browser window. In addition, certain embodiments will disable all capabilities of the web browser that are not required by the softphone graphical interface. By configuring the communication application container in this manner, certain indicators that a user would associate with a web browser would not be displayed such that the user would be less likely to manipulate the softphone user interface as a web browser. To further discourage the user from closing the softphone user interface, the user may be prompted to confirm the closing of the communication application container containing the softphone graphical interface.

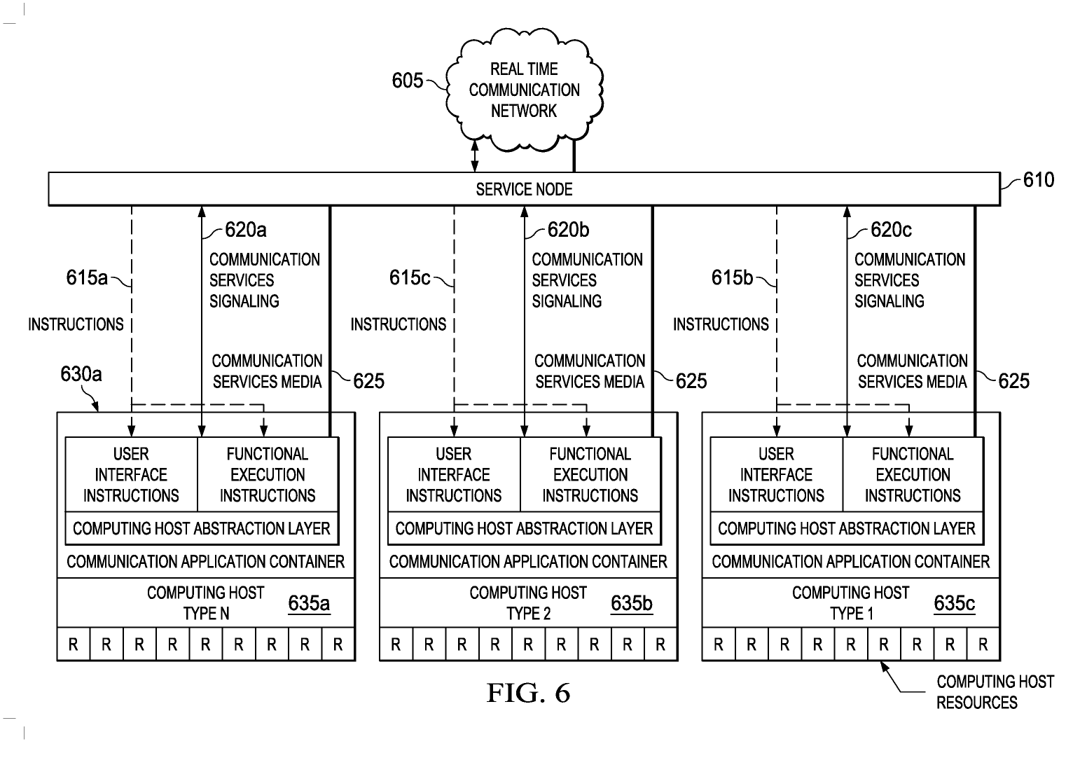

FIG. 6 illustrates the operation of a service node 610, according to certain embodiments, used to support real-time communications to a set of three computing hosts 635a-c of various types. By way of illustrative example, computing hosts 635a-c may be any one of a laptop or desktop computer, a mobile device, an embedded vehicular information/entertainment system, a virtualized operating environment, a smart television and/or a smart appliance. Regardless of the actual device that serves as a computing host 635a-c, service node 610 is configured to support providing real-time communications to computing hosts 635a-c. Service node 610 provides user interface display instruction 615a-c to the web-client display provided by the communication application container 630a-c provided by each computing host 635a-c. Service node 610 may be configured to provide display instructions 615a-c that are customized for the specific type of computing host 635a-c that will be hosting the communication session. The service node 610 provides call configuration to each communication application container 630a-c via communication services signaling pathways 620a-c. In some embodiments, service node 610 serves as a SIP endpoint on behalf of each of the communication application containers 330 630a-c. Once a call has been configured, the service node 610 transmits call data to and from the communication application containers 630a-c, such as via communication services media pathway 625.

Each of the communication application containers 630a-c includes a computing host abstraction layer that is especially adapted for interfacing with different computing host types that are supported. The computing host abstraction layer allows the service node 610 to provide generally uniform user interface instructions and functional execution instructions that are not intended for a specific computing host type. The host abstraction layer is configured to adapt the user interface instructions to the display of a particular computing host type in order to provide a consistent user interface across the different supported computing host types. The host abstraction layer may also enable the communication application container to take advantage of functionality that is specific to a particular computing host type. The host abstraction layer also allows generally uniform functional execution instructions to be used by the service node 610 as the functional instructions provided by the service node 610 are adapted by the host abstraction layer to account for differences between the supported computing host types.

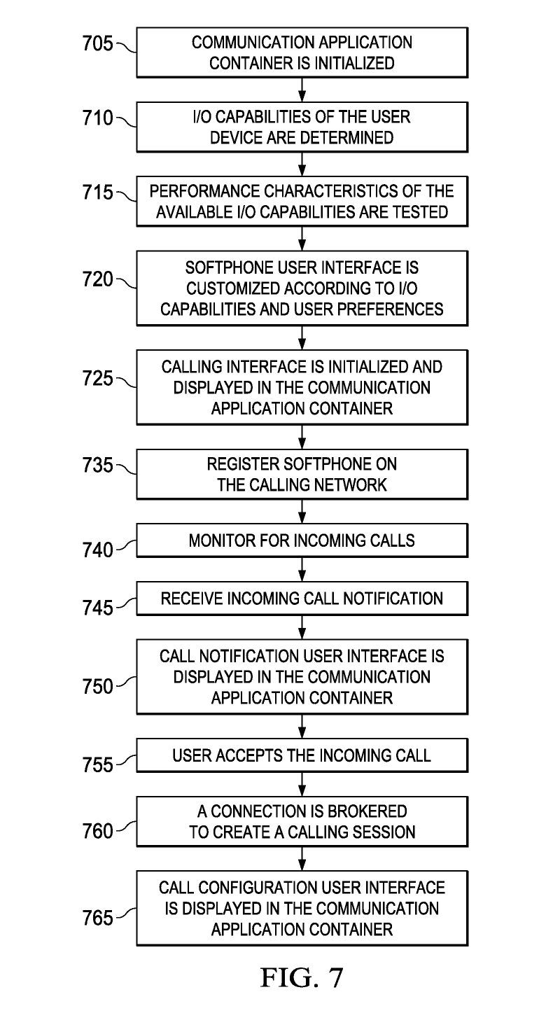

Certain of the steps described above for providing the necessary interfaces for the user to configure an incoming call from a remote party are further described in the flowchart of FIG. 7. In particular, FIG. 7 describes an embodiment that sets up the softphone graphical interface in a communication application container and configures a calling session on behalf of the user while providing the user with an appropriate user interface at each stage of the process.

in the operation of the embodiment described in FIG. 7, the process begins at step 705 with the initialization of the communication application container on the user device. The softphone graphical interface is provided to the user by a softphone client running as a process of the communication application container. In some embodiments, once the communication application container has been initialized, the softphone graphical interface is automatically instantiated and the remaining steps of the process are triggered. In other embodiments, manual user input, such as a login, is required in order to launch the softphone graphical interface.

Once the communication application container has been initialized and the softphone graphical interface has been instantiated, the configuration of the softphone graphical interface can proceed. At step 710, the status of certain capabilities of the user device are determined. The softphone client will require the use of at least the microphone and speaker of the user device in order to provide voice service. In embodiments that provide both voice and video service, the camera of the user device will also be required. In certain embodiments, including those where the softphone graphical interface is provided within a communication application container that has been configured to allow direct network access from the web browser, the network status will also be determined. In some embodiments, these capabilities will be determined on the user device via JavaScript programs executed by the browser upon instantiation of the softphone user interface. In some embodiments, proper network configuration will be determined by the softphone graphical interface performing a handshake with a service node.

At step 715, the configuration of the softphone graphical interface continues in some embodiments by providing a user interface for evaluating and configuring the settings for the user device capabilities identified in step 710. In some embodiments, a settings user interface will provide controls for adjusting the microphone of the user device. The user may be provided with the ability to test the microphone by recording the user speaking into the microphone and playing back the recorded track for the user to hear. The user can adjust the placement of the microphone and/or settings available on the user device in order to improve performance. Likewise, the user may be provided with controls for adjusting the speakers of the user device. The user may be provided the ability to play test sounds and may further be provided the ability to adjust the volume of the user device speakers. In embodiments that support video calls, the settings user interface may display a video feed from the camera of the user device. Using this video feed, the user may adjust the physical positioning of the camera and/or the camera settings provided by the user device. In some embodiments, the user will also be provided with the ability to adjust network settings. For instance, in situations where multiple network interfaces may be available, the user may be provided with the ability to choose which network interface the softphone will utilize.

At step 720, the softphone user interface is configured. As described, some embodiments may utilize a call placement graphical interface 725 as a default interface. In such embodiments, the call placement graphical interface 725 may be customized according the user's preferences. As described above, the softphone graphical interface that is displayed may be customized based on a user profile. The user profile may specify preferences settings provided by the user or other attributes of the user that may be used to customize the softphone graphical interface. Once the customized layout for the softphone user interface has been determined, the process may continue with the initialization and display of the interface on the user device at step 725.

In order to receive incoming calls, the softphone must be a recognized client of a calling network. At step 730, the softphone uses a signaling protocol such as SIP to register as a client of a calling network. As described above, SIP allows network devices to request configuration of a communication session between parties on the network. Prior to configuration of an actual SIP communication session between devices, the device endpoints must register as SIP user agents. A device that issues a SIP command registering as a user agent serves as notification that the device is ready to send and receive communications in SIP sessions. Once registered, the user agent can use additional SIP commands to invite other registered user agents to participate in a SIP communication session.

The described embodiments rely on one or more service nodes to manage registration and call configuration on behalf of the softphone. A service node thus serves as a SIP endpoint on behalf of the softphone and registers itself as a SIP user agent accordingly. Serving in this capacity as a SIP endpoint, a service node also manages SIP invites on behalf of the softphone client. In some embodiments, the softphone client may register as a SIP endpoint directly, without utilizing the services of a service node.

This registration of the softphone must be repeated at least each time the communication application container is initialized and also any other time that the softphone is started. In some embodiments, this registration process is automatically repeated each time network connectivity is reestablished after an interruption in service. Users accustomed to conventional telephone systems do not expect to have to repeatedly initialize a phone interface in order to signal that the user is ready to receive calls via the phone. Users expect that a phone device will be configured to receive calls as soon as the device has been powered and the device has been able to establish a connection to a calling network. The user can be expected to provide user credentials in order to establish connectivity to the calling network. Consequently, in some embodiments, this registration step is an automatic process.

Once registration is complete, the softphone is ready to receive calls. At step 735, the softphone monitors the calling network for incoming call requests. In the above embodiment, a service node registers as a SIP user agent endpoint on behalf of the softphone and monitors the calling network for incoming call requests seeking to establish a call with the user. In some embodiments, the communication application container may register as a SIP user agent and monitor the calling network. At step 740, incoming SIP call invites are received by the component that has registered as the SIP agent on behalf of the softphone. In the embodiments above, the SIP call invites are received at a service node and forwarded to the communication application container.

At step 745, the user is notified of the incoming call request. In the embodiment of FIG. 5, the user is notified of a call via a call notification graphical interface 535 that may be a pop-up dialog. The display of the call notification graphical interface 535 is triggered by the receipt of the incoming call request at the communication application container. In response to receiving the call request in certain embodiments, the communication application container signals the display of the call notification graphical interface 535 on the virtual desktop. As described, the display and behavior of the call notification graphical interface 535 may be configured to comport with a user's expectations for a calling device.

At step 750, the user accepts the incoming call invite via a control provided by the call notification graphical interface 735. User input to the call notification graphical interface 535 is transmitted from the communication application container to a service node. Based on the user's acceptance of the call invite, at step 760, a service node uses a signaling protocol such as SIP to establish a call session between the user device and the device of the inviting party.

Once the configuration of the call is complete, the softphone display can be updated to display the call configuration graphical interface 530 that is described above with respect to the embodiment of FIG. 5. As described, the call configuration graphical interface 530 includes controls by which a user may alter an ongoing call. For instance, the call configuration graphical interface 530 may include controls for adding a party to an ongoing call and/or placing callers on hold. As described, the call configuration graphical interface 530 may be configured to remain as a visible window in the virtual desktop.

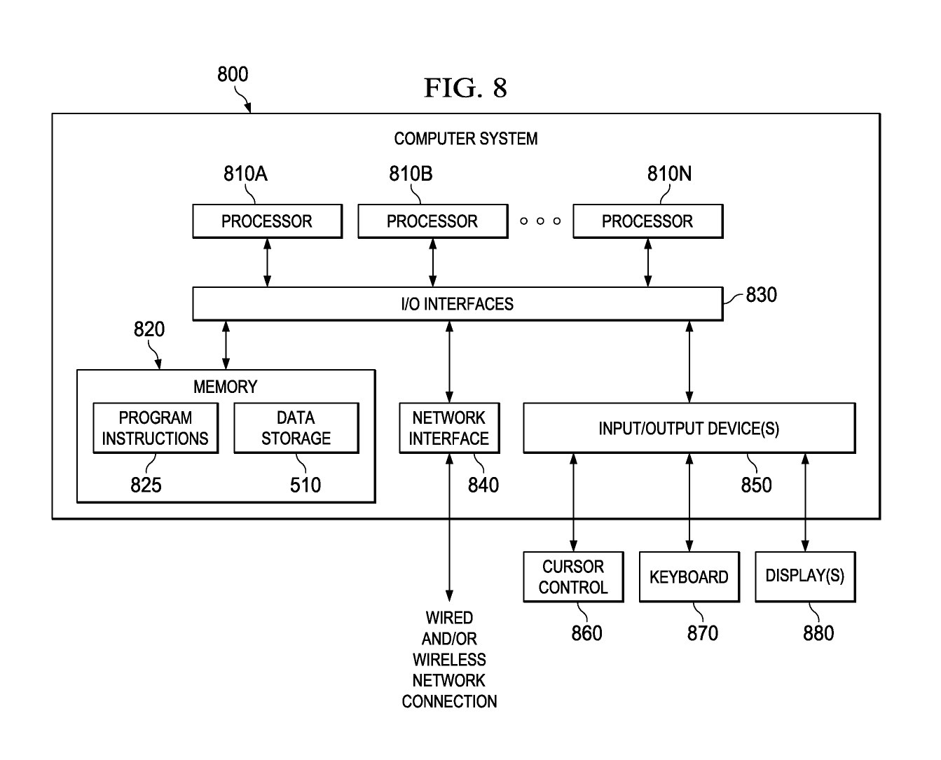

The service node, the user device and the remote server described with regard to the preceding embodiments may each be implemented or executed, at least in part, by one or more computer systems. One such computer system is illustrated in FIG. 8. In various embodiments, computer system 800 may be a server, a workstation, a desktop computer, a laptop, a microcontroller, a system on a chip or the like. In some embodiments, system 800 may be used to implement the real-time communications configuration functions of FIGS. 2-7. As illustrated, computer system 800 includes one or more processor(s) 810A-N coupled to a system memory 820 via an input/output (I/O) interface 830. Computer system 800 further includes a network interface 840 coupled to I/O interface 830, and one or more input/output devices 850, such as cursor control devices 860, keyboard 870, and display(s) 880.

In various embodiments, computer system 800 may be a single-processor system including one processor 800A, or a multi-processor system including two or more processors 810A-N two, four, eight, or another suitable number). Processor(s) 810A-N may include any processor capable of executing program instructions. For example, in various embodiments, processor(s) 810A-N may be general-purpose or embedded processors implementing any of a variety of instruction set architectures (ISAs), such as the x86, PowerPC®, ARM®, SPARC®, or MIPS® ISAs, or any other suitable ISA. In multi-processor systems, each of processor(s) 810A-N may commonly, but not necessarily, implement the same ISA.

System memory 820 may be configured to store program instructions (e.g., the real-time communications configuration functions) and/or data accessible by processor(s) 810A-N. In various embodiments, system memory 820 may be implemented using any suitable memory technology, such as static random access memory (SRAM), synchronous dynamic RAM (SDRAM), nonvolatile/Flash-type memory, or any other type of memory. As illustrated, program instructions and data implementing certain operations such as, for example, those described in connection with FIGS. 3-7, may be stored within system memory 820 as program instructions 825 and data storage 835, respectively. Additionally or alternatively, the real-time communications configuration functions may be a software program that is stored within system memory 820 and is executable by processor(s) 810A-N. In other embodiments, program instructions and/or data may be received, sent or stored upon different types of computer-accessible media or on similar media separate from system memory 820 or computer system 800. Generally speaking, a computer-accessible medium may include any tangible or non-transitory storage media or memory media such as electronic, magnetic, or optical media e.g., disk or CD/DVD-ROM coupled to computer system 800 via I/O interface 830. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, I/O interface 830 may be configured to coordinate I/O traffic between processor(s) 810A-N, system memory 820, and any peripheral devices in the device, including network interface 840 or other peripheral interfaces, such as input/output devices 850. In some embodiments, I/O interface 830 may perform any necessary protocol, timing or other data transformations to convert data signals from one component (e.g., system memory 820) into a format suitable for use by another component (e.g., processor(s) 810A-N). In some embodiments, I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components, such as a north bridge and a south bridge, for example. In addition, in some embodiments some or all of the functionality of I/O interface 830, such as an interface to system memory 820, may be incorporated directly into processor(s) 810A-N.

Network interface 840 may be configured to allow data to be exchanged between computer system 800 and other devices attached to a network, such as between a service node and a user device. In various embodiments, network interface 840 may support communication via wired or wireless general data networks, such as any suitable type of Ethernet network, for example; via telecommunications/telephony networks such as analog voice networks or digital fiber communications networks; via storage area networks such as FibreChannel SANs, or via any other suitable type of network and/or protocol.

Input/output devices 850 may, in some embodiments, include one or more display terminals, keyboards, keypads, touchpads, scanning devices, RFID readers, NFC readers, voice or optical recognition devices, or any other devices suitable for entering or retrieving data by one or more computer system 800. Multiple input/output devices 850 may be present in computer system 800 or may be distributed on various nodes of computer system 800. In sonic embodiments, similar input/output devices may be separate from computer system 800 and may interact with one or more nodes of computer system 800 through a wired or wireless connection, such as over network interface 840.

As shown in FIG. 8, memory 820 may include program instructions 825, configured to implement certain embodiments described herein, and data storage 835, comprising various data may be accessible by program instructions 825. In an embodiment, program instructions 825 may include software elements of embodiments illustrated in the above figures. For example, program instructions 825 may be implemented in various embodiments using any desired programming language, scripting language, or combination of programming languages and/or scripting languages (e.g., C, C++, C#, Java™, JavaScript™, Perl, etc.). Data storage 835 may include data that may be used in these embodiments (e.g., user profiles, call logs, recorded communications, address book information, contact lists, user preferences, profiles for different modes of operations, etc.). In other embodiments, other or different software elements and data may be included.

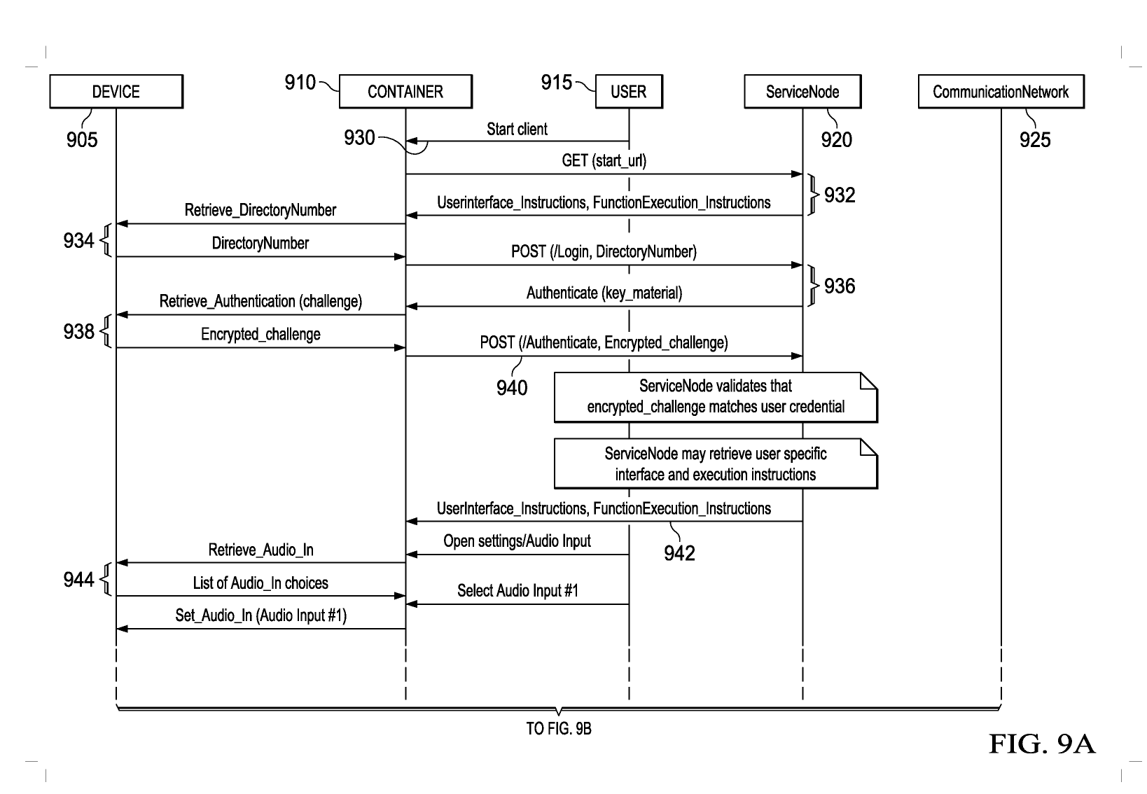

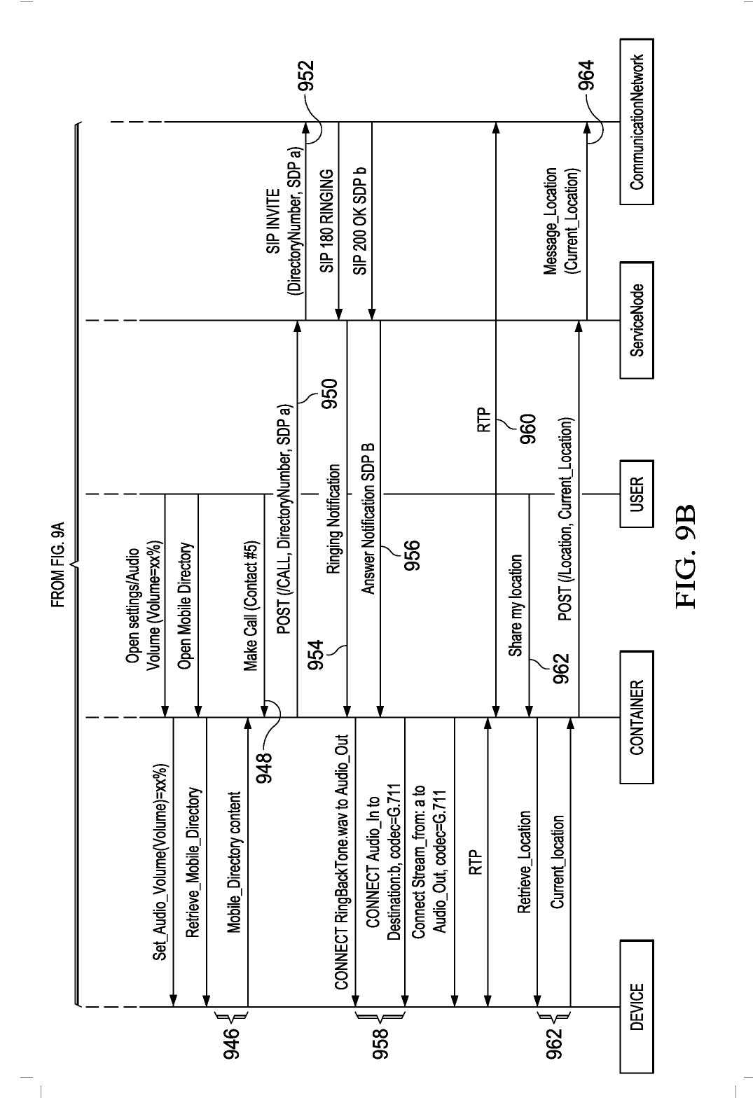

FIGS. 9A and 9B illustrate a call flow diagram that illustrates the operation of a real-time communications client according to various embodiments. A user 915 operates the real-time communications client via a communication application container 910 that includes a graphical interface displayed on a user device 905. As described with regard to the prior embodiments, the communication application container 910 provides the real-time communication client to the user 915 such that the real-time communication client can be manipulated similar to a native application of the user device 905. The real-time communications client utilizes a service node 920 to manage registration and call configuration functions. In order to provide these call functions, the service node 920 communicates with other service nodes via a communication network 925.

The configuration scenario illustrated in FIGS. 9A and 9B begins with the authentication of the user 915. In the illustrated embodiment, this authentication process is triggered by the user 915 issuing a command 930 to initiate the real-time communication client. This command 930 is received by the communication application container 910. In response to the command 930, the communication application container 910 issues a request 932 to the service node 920 for an authentication interface. The service node 920 responds by providing the communication application container 910 with instructions 932 for display and operation of the authentication interface. The communication application container 910 proceeds by retrieving 934 the directory number associated with the user device 905. The communication application container 910 utilizes the user's directory number to issue a login request 936 to the service node 920. Based on the supplied directory number, the service node 920 generates an authentication request that is used to confirm the identity of the user 915. Based on the authentication request, communication application container 910 issues a challenge 938 to the user device 905. In the illustrated embodiments, the issued challenge may be responded to by the device 938 without input from the user 915. Other embodiments may utilize input from the user 915 in responding to a challenge request. Challenge responses are encrypted by the user device 905 and forwarded 940 to the service node 920. The service node 920 completes the authentication by comparing 940 the provided challenge response against the previously provided credentials associated with the provided directory number.

Once the identity of a user 915 has been authenticated, the service node 920 proceeds by retrieving 942 any customizations to the real-time communications client that are associated with this user. As described above, the communication application container 910 operates similar to a web browser in that the graphical display is provided from a server, in this case the service node 920. The service node 920 incorporates any customizations to the real-time communications client graphical interface. The graphical interface and instructions for display and operation of the real-time communications client are then communicated 942 to the communication application container 910 where it can then be displayed on the user device 905.

Prior to the display and use of the real-time communications client, certain configuration procedures may be utilized. In the embodiment of FIGS. 9A and 9B, configuration of the real-time communications client includes a procedure 944 for setting up the use of audio capabilities provided by the user device 905. The audio configuration procedure begins with the communication application container 910 providing an audio settings graphical interface to the user 915. The communication application container 910 queries the available audio input mechanisms that are provided by the user device 905. For instance, the user device 905 may include a built-in microphone or may be configured to use an external microphone such as a BLUETOOTH headset. Via the provided audio settings graphical interface, the user 915 selects from the available audio input mechanisms.

The scenario illustrated in FIGS. 9A and 9B continues with the initiation of an outgoing call by the user 915. Before imitating a call, the user 915 is provided with a listing of directory numbers stored on the user device 905. In some scenarios, the listing of directory numbers associated with the user 915 is retrieved from the service node 920. The retrieved listing of directory numbers is provided 946 to the user by the communication application container 910. The user 915 selects 948 a directory number from the provided listing. An outgoing call to the selected directory entry is initiated 950 by the communication application container 910 issuing a call request to the service node 920. As described, the service node 920 may be configured to operate as a SIP endpoint on behalf of the real-time communications client. Via the communication network 925, the service node 920 directs a SIP invite 952 to the directory number selected by the 915. Once the invite has been issued and becomes upending call, a ringing notification is issued 954 to the user via a ring tone played through the audio output of the user device 905.

If the user responds to the SIP invite 952 by answering the call, an answer notification 956 is communicated to the service node 920 via the communication network 925. The answer notification 956 is then relayed to the user device 905 by configuring 958 a streaming audio connection from the communication application container 910 to the user device 905. Now connected, the call data is communicated 960 via RTP between the user device 905 and the remote party. In other embodiments, the communication application container 910 may utilize communication mechanisms other than RTP to communicate call data.

In certain embodiments, the call may continue with the sharing of location information by the user 915. In such embodiments, a user 915 signals via an interface of the real-time communications client to share a present location with the remote party. This signal is received by the communication application container 910, which then proceeds to retrieve 962 the location of the user, as provided by the location functions of the user device 905. This location information is then relayed from the communication application container 910, to the service node 920 and is forwarded 964 to the remote party via the communication network 925.

A person of ordinary skill in the art will appreciate that computer system 800 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system or processor-based configurations.

Although certain embodiments are described herein with reference to specific examples, numerous modifications and changes may be made in light of the foregoing description. Accordingly, the specification and figures are to be regarded in an illustrative rather than a restrictive sense, and all such modifications are intended to be included within their scope. Any benefits, advantages, or solutions to problems that are described herein with regard to specific embodiments are not to be construed as a critical, required, or essential feature or element of any or all the claims. Furthermore, it should be understood that the various operations described herein may be implemented in software, hardware, or a combination thereof. The order in which each operation of a given technique is performed may be changed, and the elements of the systems illustrated herein may be added, reordered, combined, omitted, modified, etc. It is intended that the embodiments described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The term “coupled” is defined as “connected” and/or “in communication with,” although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method for providing real-time communication services to a user, the method comprising:
providing user interaction instructions and functional execution instructions to a communication application container executing on a computing host, wherein the user interaction instructions include instructions for the display of a real-time communications graphical interface by a web client component of the communication application container, and wherein the functional instructions include instructions for configuring one or more native resources of the computing host;
configuring a real time communication service based on user input to the real-time communications graphical interface; and
providing a real time communication service based on the functional execution instructions executing on the communication application container, wherein the real time communication service utilizes the configured native resources of the computing host.

2. The method of claim 1, wherein the functional execution instructions for configuring one or more native resources of the computing host include instructions for at least one of: selecting an audio input device; controlling parameters such as volume, echo cancellation and codec type that are associated with a selected audio input device; selecting a video input device; controlling parameters, such as resolution, frame rate, codec type, that are associated with a selected video input device; selecting an audio output device for user alerts; selecting an audio output device for communication media; recording locally a communication session; getting current location data, such as GPS, WiFi, and cellular cell data; obtaining list of available network interface; selecting a network interface for a communication flow; getting network quality metrics for a network interface, accessing or updating a personal directory provided by a computing host; authentication via a SIM card; authentication via a fingerprint reader; launching another application on the computing host; presenting a visual notification for an event via the computing host notification methods; controlling windows formatting; receiving touch events from a touchscreen; configuring a cellular network dialer for normal and emergency calls; configuring cellular messaging; and configuring cellular RCS (Rich Communication Services),

3. The method of claim 1, wherein the user interaction instructions are web-based instructions comprising one of HTML, HTML5, JAVASCRIPT and CSS.

4. The method of claim 1, wherein the real time communication service is provided using one of: REST, SOAP, and JSON.

5. The method of claim 1, wherein the real time communication service is configured via a real time communication network using SIP.

6. The method of claim 1, wherein the communication application container transmits real time communication media using RTP.

7. The method of claim 1, wherein the real-time communications graphical interface provides a primary telephony or messaging user interface, and wherein the computing host is a mobile device.

8. The method of claim 1, wherein the real time communication services include at least one of: audio, video, messaging, screen sharing, application sharing, co-browsing, whiteboard sharing, annotation, remote control, and streaming.

9. The method of claim 1, wherein the communication application container includes an abstraction layer which provides a consistent interface for the user interaction instructions and functional execution instructions across different computing host types.

10. The method of claim 10, wherein the user interaction instructions are selected based on a user profile.

11. A system for providing real-time communication services to a user, the system comprising:
a processor; and
a memory coupled to the processor, the memory storing computer-readable instructions that, upon execution by the processor, cause the system to:
provide user interaction instructions and functional execution instructions to a communication application container executing on a computing host, wherein the user interaction instructions include instructions for the display of a real-time communications graphical interface by a web client component of the communication application container, and wherein the functional instructions include instructions for configuring one or more native resources of the computing host;
configure a real time communication service based on user input to the real-time communications graphical interface; and
providing a real time communication service based on the functional execution instructions executing on the communication application container, wherein the real time communication service utilizes the configured native resources of the computing host.

12. The system of claim 11, wherein the functional execution instructions for configuring one or more native resources of the computing host include instructions for at least one of: selecting an audio input device; controlling parameters such as volume, echo cancellation and codec type that are associated with a selected audio input device, selecting a video input device; controlling parameters, such as resolution, frame rate, codec type, that are associated with a selected video input device; selecting an audio output device for user alerts; selecting an audio output device for communication media; recording locally a communication session; getting current location data, such as GPS, WiFi, and cellular cell data; obtaining list of available network interface; selecting a network interface for a communication flow; getting network quality metrics for a network interface; accessing or updating a personal directory provided by a computing host, authentication via a SIM card, authentication via a fingerprint reader; launching another application on the computing host; presenting a visual notification for an event via the computing host notification methods; controlling windows formatting; receiving touch events from a touchscreen; configuring a cellular network dialer for normal and emergency calls; configuring cellular messaging; and configuring cellular RCS (Rich Communication Services).

13. The system of claim 11, wherein the user interaction instructions are web-based instructions comprising one of: HTML, HTML5, JAVASCRIPT and CSS.

14. The system of claim 11, wherein the real time communication service is provided using one of: REST. SOAP, and JSON.

15. The system of claim 11, wherein the real time communication service is configured via a real time communication network using SIP.

16. The system of claim 11, wherein the communication application container transmits real time communication media using RTP.

17. The system of claim 11, wherein the real-time communications graphical interface provides a primary telephony or messaging user interface, and wherein the computing host is a mobile device.

18. The system of claim 11, wherein the real time communication services include at least one of: audio, video, messaging, screen sharing, application sharing, co-browsing, whiteboard sharing, annotation, remote control, and streaming.

19. The system of claim 11, wherein the communication application container includes an abstraction layer which provides a consistent interface for the user interaction instructions and functional execution instructions across different computing host types.

20. A method for providing real-time communication services to a user of a computing host, the method comprising:
receiving user interaction instructions and functional execution instructions, wherein the user interaction instructions include instructions for the display of a real-time communications graphical interface by a web client component;
configuring, based on the functional instructions, one or more native resources of the computing host;
receiving, based on the user interaction instructions, input to the real-time communications graphical interface, wherein the input is provided by the user and wherein the input includes a request for a real-time communication service; and
providing, based on the functional instructions, the requested real time communication service utilizing the configured native resources of the computing host.
